(19) United States
(12) Patent Application Publication
(10) Pub. No.: US 2017/0169062 A1
(43) Pub. Date: Jun. 15, 2017

(54) METHOD AND ELECTRONIC DEVICE FOR RECOMMENDING VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lijun DUAN, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,881

(22) Filed: Aug. 19, 2016

Related U.S. Application Data
(63) Continuation of application No. PCT/CN2016/089524, filed on Jul. 10, 2016.

(30) Foreign Application Priority Data
Dec. 14, 2015 (CN) 2015109234428

(51) Int. Cl. G06F 17/30

(52) U.S. Cl. CPC G06F 17/30303; G06F 17/30864; G06F 17/30817

(57) ABSTRACT

A method and electronic device for recommending a video are provided. The method includes: acquiring hot words and attributes of the hot words provided by a search engine; sorting the hot words according to the attributes of the hot words; and recommending videos according to the sorted hot words. By comprehensively considering factors such as a rank of a video hot word and occurrence time of the hot word, etc., the recommended video is allowed to be more accordant to current hot spots.

### CROSS REFERENCE TO RELATED APPLICATIONS

The application is a continuation application of PCT application No. PCT/CN2016/089524 submitted on Jul. 10, 2016. The present application claims priority to Chinese Patent Application No. 201510923442. 8, filed with the Chinese Patent Office on Dec. 14, 2015 and entitled “METHOD, SYSTEM AND SERVER FOR RECOMMENDING VIDEO”, both of which are incorporated herein by reference in its entireties.

### TECHNICAL FIELD

The present disclosure relates to the field of network videos, and in particular, to a method and an electronic device for recommending a video.

### BACKGROUND

A server may push a hot video to a client to attract a user to click or watch. However, generally a video is recommended according to a viewer number of the video; consequently, a probability of a new video to be recommended becomes small; in addition, some videos accumulate a large viewer number due to the existence time thereof; however, because a ratio of the viewer number to the existence time thereof is small, and a user may lose interest in the videos.

### SUMMARY

An objective of the present disclosure is to provide a method and an electronic device for recommending a video, so as to recommend a hot video to a user in different manners.

According to a first aspect, an embodiment of the present disclosure provides a video recommendation method, where the method includes: acquiring hot words and attributes of the hot words provided by a search engine; sorting the hot words according to the attributes of the hot words; and recommending videos according to the sorted hot words.

According to a second aspect, an embodiment of the disclosure further provides a non-transitory computer-readable storage medium, which stores a computer executable instruction that, when executed by an electronic device, cause the electronic device to execute any one of the mentioned methods for recommending video prescribed by the present disclosure.

According to a third aspect, an embodiment of the disclosure further provides an electronic device, including: at least one processor; and a memory in communication connection with the at least one processor. The memory stores an instruction that can be executed by the at least one processor, and the instructions is executed by the at least one processor causes the at least one processor can execute any of the foregoing video recommending methods of the disclosure.

The embodiments of the present disclosure recommend a video by comprehensively considering factors such as a rank of a video hot word, occurrence time of the hot word occurs, etc., thereby making the recommended video more accordant with current hot spots.

### BRIEF DESCRIPTION OF THE DRAWINGS

One or more embodiments are exemplarily described by figures corresponding thereto in the accompanying drawings; the exemplary descriptions do not constitute a limitation on the embodiments. Elements with the same reference numbers in the accompanying drawings are similar elements. Unless otherwise particularly stated, the figures in the accompanying drawings do not constitute a scale limitation. In the accompanying drawings:

FIG. 1 is a schematic diagram of a video recommendation method provided by an embodiment of the present disclosure;

FIG. 2 is a flowchart of a deduplication operation provided by an embodiment of the present disclosure;

FIG. 3 is a schematic diagram of a server provided by an embodiment of the present disclosure;

FIG. 4 is a schematic diagram of a video recommendation system provided by an embodiment of the present disclosure; and

FIG. 5 is a schematic structural diagram of hardware of an electronic device for executing a video recommending method provided in an embodiment of the disclosure.

DESCRIPTION OF REFERENCE NUMBERS

| | | | |
|---|---|---|---|
| 100 | Acquiring module | 200 | Sorting module |
| 300 | Recommending module | 500 | Server |
| 600 | Client | | |

### DETAILED DESCRIPTION

The following describes specific implementation manners of the present disclosure in detail with reference to the accompanying drawings. It should be understood that the specific implementation manners described herein are merely used for describing and explaining the present disclosure, and are not used to limit the present disclosure.

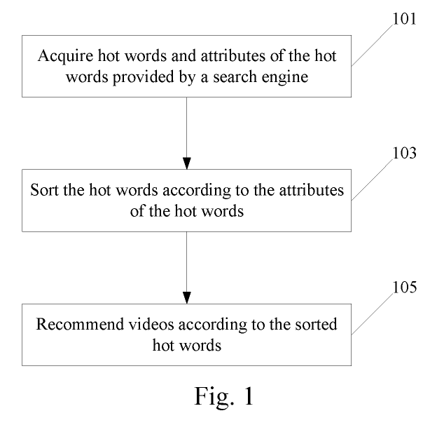

To recommend videos to a user more accurately, an embodiment of the present disclosure provides the following implementation manner; as shown in FIG. 1, which specifically includes:

In step 101: hot words and attributes of the hot words provided by a search engine are acquired; sorting the hot words according to the attributes of the hot words (step 103); and recommending videos according to the sorted hot words (step 105).

Currently, some search engines, for example, Baidu, etc., provide hot word lists; the present disclosure can automatically crawl hot words and attributes of the hot words in the hot word lists by using the crawler protocol, so as to recommend videos by using the hot words. The attributes of the hot words include ranks of the hot words and occurrence time of the hot words, etc. Alternatively, manually acquiring hot words may also be possible, for example, manually checking first 50 hot words in the hot word list, and recording hot words and occurrence time of the hot words. A hot word library may be formed by means of continual crawling or recording, for example, crawling or recording once every day. It may be preset to only keep hot words in a predetermined time period, for example, crawling or recording once every day, to form a hot word library for 3 successive days. Expired hot words may be deleted, or are not considered if kept; that is, the expired hot words, for example, hot words before three days, are not considered when hot words are sorted.

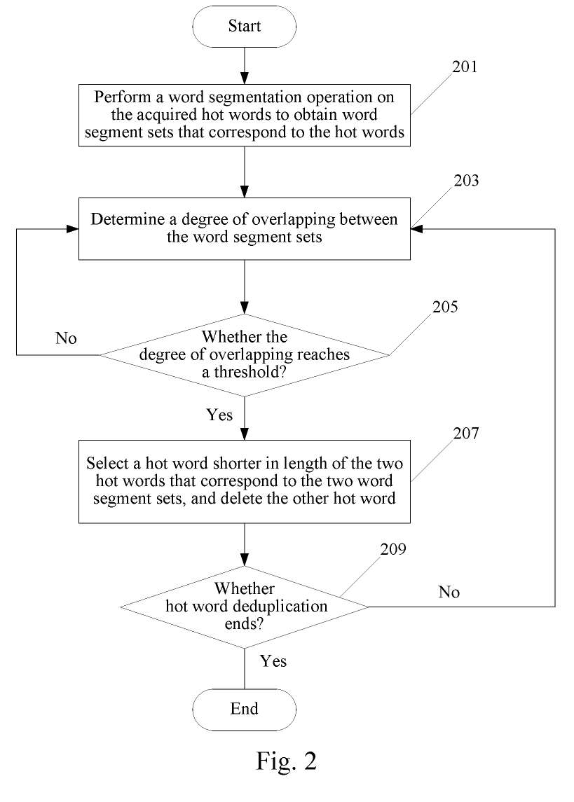

To reduce hot words, a deduplication operation needs to be performed on hot words. A technical solution existing in prior art may be used for the deduplication operation. In this embodiment of the present disclosure, the deduplication operation may be performed by means of the solution shown in FIG. 2, which specifically includes: a word segmentation operation is performed on the acquired hot words to obtain word segment sets that correspond to the hot words (step 201); a degree of overlapping is determined between the word segment sets (step 203); determining whether the degree of overlapping between two word segment sets reaches a threshold (step 205); if the threshold is reached, then selecting a hot word shorter in length of the two hot words that correspond to the two word segment sets, and deleting the other hot word (step 207); and further determining whether a comparison between the degree of overlapping between any two sets and the threshold is completed (step 209), that is, determining whether the deduplication operation ends, and if the hot word deduplication operation ends, then ending the entire process, and otherwise continuing to perform step 203. If step 205 determines that the degree of overlapping does not exceed the threshold, then a degree of overlapping comparison between the word segment sets is continuously performed, and step 203 is performed. In the deduplication process, whether the degree of overlapping between any two word segments reaches the threshold needs to be traversed; if the threshold is reached, a shorter one of the corresponding hot words is selected, and the other one is deleted. In this way, a needed operation amount can be reduced. The degree of overlapping may be determined according to a quantity of the same word segments in an individual set, for example, by dividing a quantity of the same word segments in two word segment sets by a quantity of word segments in a word segment set that has the least word segments; if 80% is reached, then it can be considered that the degree of overlapping between the two word segment sets reaches a threshold. For example, by comparing hot words “Apple's launch event” and “Apple's launch event 2015,” they can be considered as repetitive hot words, and “Apple's launch event 2015” is deleted to obtain a processed hot word “Apple's launch event.”

After the deduplication operation is performed, the duplicated hot words may be sorted, and videos may be further recommended according to the sorted duplicated hot words.

In a process of sorting the hot words, hot word attributes such as ranks of the hot words and occurrence time of the hot words, may be used. Hot word attributes used in this embodiment of the present disclosure are not limited thereto, and both are described only as examples herein.

In the sorting process, at least one of trend evaluations, time evaluations of the hot words, and rank evaluations of the hot words can be determined. As an example, the trend evaluations, the time evaluations of the hot words, and the rank evaluations of the hot words can be synchronously determined. Specifically, within a period from a predetermined start time to a predetermined end time, the higher the hot words rank at the end time, the higher at least one of the trend evaluations of the hot words, the time evaluations of the hot words, and the rank evaluations of the hot words are. For example, in a case in which hot words for recent three days are used to recommend videos, a trend evaluation may be determined according to a variation in a rank of a hot word in the past 3 days; for example, if the rank ascends, the trend evaluation is set as a score of 3; if the rank does not change, the trend evaluation is set as a score of 2; and if the rank descends, the trend evaluation is set as a score of 1; a time evaluation may be set in the following manner; if the hot word ranks highest on the last day, then a score of 3 is given; if the hot word ranks highest on the first day, then a score of 1 is given, and if the hot word ranks highest on the second day, then a score of 2 is given; a rank evaluation of the hot word may be a score relevant to a current rank; the higher a current rank is, the higher a score is, for example, by collecting statistics on 50 hot words, a rank score of the hot word may be calculated by subtracting a current rank of the hot word from 51, so as to reflect a rank condition of the hot word.

By performing calculation on the foregoing word segments by using operators, for example, multiplying the foregoing parameters, or multiplying first three parameters, and calculating a sum of a product of the first three parameters and a product of last two parameters as a rank basis, hot videos can be ranked, and are recommended to a user, thereby improving experience of the user watching videos.

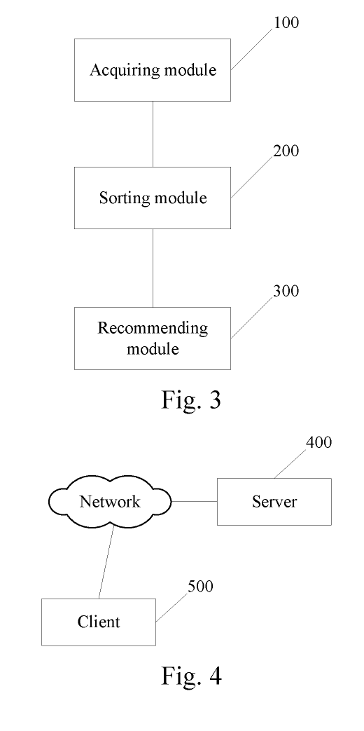

Correspondingly, an embodiment of the present disclosure provides a server. As shown in FIG. 3, the server includes:

an acquiring module 100, acquires hot words and attributes of the hot words provided by a search engine; a sorting module 200 configured to sort the hot words according to the attributes of the hot words; and a recommending module 300 configured to recommend videos according to the sorted hot words. As an example, the acquiring module 100 further performs a deduplication operation on the hot words, so that the sorting module 200 may perform sorting by using the duplicated hot words, and the recommending module may recommend videos according to the duplicated hot words.

Correspondingly, an embodiment of the present disclosure provides a video recommendation system, as shown in FIG. 4, which includes a server 400 and a client 500, where the client is mainly used to display videos recommended by the server.

Correspondingly, an embodiment of this disclosure provides a non-transitory computer-readable storage medium, which stores a computer executable instruction that, when executed by an electronic device, cause the electronic device to execute any one of the mentioned methods for recommending video prescribed by the present disclosure.

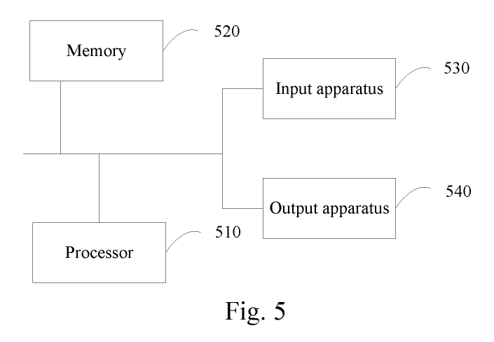

Correspondingly, FIG. 5 is a schematic structural diagram of hardware of an electronic device for executing a video recommending method provided in an embodiment of the disclosure. As shown in FIG. 5, the electronic device includes:

one or more processors 510 and a memory 520, with one processor 510 as an example in FIG. 5.

The electronic device for executing the video recommending method may further include: an input apparatus 530 and an output apparatus 540.

The processor 510, the memory 520, the input apparatus 530, and the output apparatus 540 can be connected by means of a bus or in other manners, with a connection by means of a bus as an example in FIG. 5.

As a non-transitory computer-readable readable storage medium, the memory 520 can be used to store non-transitory software programs, non-transitory computer-readable executable programs and modules, for example, a program instruction/module corresponding to the video recommending method in the embodiments of this disclosure (for example, the acquiring module 100, the sorting module 200, and the recommending module 300 shown in FIG. 3). The processor 510 executes various functional disclosures and data processing of the server, that is, implements the video recommending method of the foregoing method embodiments, by running the non-transitory software programs, instructions, and modules stored in the memory 520.

The memory 520 may include a program storage area and a data storage area, where the program storage area may store an operating system and at least one disclosure needed by function; the data storage area may store data created according to use of the server, and the like. In addition, the memory 520 may include a high-speed random access memory, and also may include a non-transitory memory such as at least one disk storage device, flash storage device, or other non-transitory solid-state storage devices. In some embodiments, the memory 520 optionally includes memories remotely disposed with respect to the processor 510, and the remote memories may be connected, via a network, to the server. Examples of the foregoing network include but are not limited to: the Internet, an intranet, a local area network, a mobile communications network, and a combination thereof.

The input apparatus 530 can receive entered digits or character information, and generate key signal inputs relevant to user setting and functional control of the server. The output apparatus 540 may include a display device, for example, a display screen, etc.

The one or more modules are stored in the memory 520, and execute the video recommending method in any of the foregoing method embodiments when being executed by the one or more processors 510.

The foregoing product can execute the method provided in the embodiments of this disclosure, and has corresponding functional modules for executing the method and beneficial effects. The method provided in the embodiments of this disclosure can be referred to for technical details that are not described in detail in this embodiment.

The electronic device in the embodiments of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer,buthigher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting there on. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A video recommendation method applied in an electronic device, comprising:
acquiring hot words and attributes of the hot words provided by a search engine;
sorting the hot words according to the attributes of the hot words; and
recommending videos according to the sorted hot words.

2. The video recommendation method according to claim 1, further comprising:
performing a deduplication operation on the acquired hot words; and then, the sorting the hot words according to the attributes of the hot words comprising:
sorting, according to attributes of the hot words obtained from the deduplication operation, the duplicated hot words; the recommending videos according to the sorted hot words comprising:
recommending videos according to the sorted duplicated hot words.

3. The video recommendation method according to claim 2, wherein the performing a deduplication operation on the acquired hot words comprises:
performing a segmentation operation on the acquired hot words to obtain segment sets that correspond to the hot words;
determining a degree of overlap between the word segment sets; and
in a case in which the degree of overlap between two word segment sets reaches a threshold, selecting a hot word shorter in length of two hot words that correspond to the two segment sets, and deleting the other hot word.

4. The video recommendation method according to claim 1, wherein the attributes of the hot words comprise ranks of the hot words and occurrence time of the hot words.

5. The video recommendation method according to claim 4, wherein the sorting the hot words according to the attributes of the hot words comprises:
determining at least one of trend evaluations of the hot words, time evaluations of the hot words, and rank evaluations of the hot words; and
sorting the hot words according to at least one of the trend evaluations of the hot words, the time evaluations of the hot words, and the rank evaluations of the hot words.

6. The video recommendation method according to claim 5, wherein within a period from a predetermined start time to a predetermined end time, the higher the hot words rank at the end time, that the higher at least one of the trend evaluations of the hot words, the time evaluations of the hot words, and the rank evaluations of the hot words are.

7.-13. (canceled)

14. A non-transitory computer-readable storage medium, which stores computer executable instructions that, when executed by an electronic device, cause the electronic device to:
acquire hot words and attributes of the hot words provided by a search engine;
sort the hot words according to the attributes of the hot words; and
recommend videos according to the sorted hot words.

15. The non-transitory computer-readable storage medium according to claim 14, wherein the electronic device is further caused to:
perform a deduplication operation on the acquired hot words; then the instructions to sort the hot words according to the attributes of the hot words cause the electronic device to:
sort, according to attributes of the hot words obtained from the deduplication operation, the duplicated hot words; wherein the instructions to recommend videos according to the sorted hot words cause the electronic device to:
recommend videos according to the sorted duplicated hot words.

16. The non-transitory computer-readable storage medium according to claim 15, wherein the instructions to perform a deduplication operation on the acquired hot words cause the electronic device to:
perform a segmentation operation on the acquired hot words to obtain segment sets that correspond to the hot words;
determine a degree of overlap between the segment sets; and
in a case in which the degree of overlap between two word segment sets reaches a threshold, select a hot word shorter in length of two hot words that correspond to the two word segment sets, and delete the other hot word.

17. The non-transitory computer-readable storage medium according to claim 14, wherein the attributes of the hot words comprise ranks of the hot words and occurrence time of the hot words.

18. The non-transitory computer-readable storage medium according to claim 17, wherein the instructions to sort the hot words according to the attributes of the hot words cause the electronic device to:
determine at least one of trend evaluations of the hot words, time evaluations of the hot words, and rank evaluations of the hot words; and
sort the hot words according to at least one of the trend evaluations of the hot words, the time evaluations of the hot words, and the rank evaluations of the hot words.

19. The non-transitory computer-readable storage medium according to claim 18, wherein within a period from a predetermined start time to a predetermined end time, the higher the hot words rank at the end time, the higher at least one of the trend evaluations of the hot words, the time evaluations of the hot words, and the rank evaluations of the hot words are.

20. An electronic device, comprising:
at least one processor; and
a memory in communication connection with the at least one processor, wherein
the memory stores instructions that can be executed by the at least one processor,
wherein execution of the instructions by the said at least one processor causes the at least one processor to:
acquire hot words and attributes of the hot words provided by a search engine;
sort the hot words according to the attributes of the hot words; and
recommend videos according to the sorted hot words.

21. The electronic device according to claim 20, wherein the at least one processor is further caused to:
perform a deduplication operation on the acquired hot words; then the execution of the instructions to sort the hot words according to the attributes of the hot words cause the at least one processor to:
sort, according to attributes of the hot words obtained from the deduplication operation, the duplicated hot words; wherein the execution of the instructions to recommend videos according to the sorted hot words cause the at least one processor to:
recommend videos according to the sorted duplicated hot words.

22. The electronic device according to claim 21, wherein the execution of the instructions to perform a deduplication operation on the acquired hot words cause the at least one processor to:
perform a segmentation operation on the acquired hot words to obtain segment sets that correspond to the hot words;
determining a degree of overlap between the word segment sets; and
in a case in which the degree of overlap between two word segment sets reaches a threshold, select a hot word shorter in length of two hot words that correspond to the two word segment sets, and deleting the other hot word.

23. The electronic device according to claim 20, wherein the attributes of the hot words comprise ranks of the hot words and occurrence time of the hot words.

24. The electronic device according to claim 23, wherein the execution of the instructions to sort the hot words according to the attributes of the hot words causes the at least one processor to:
determine at least one of trend evaluations of the hot words, time evaluations of the hot words, and rank evaluations of the hot words; and
sort the hot words according to at least one of the trend evaluations of the hot words, the time evaluations of the hot words, and the rank evaluations of the hot words.

25. The electronic device according to claim 24, wherein within a period from a predetermined start time to a predetermined end time, the higher the hot words rank at the end time, the higher at least one of the trend evaluations of the hot words, the time evaluations of the hot words, and the rank evaluations of the hot words are.
